(19) United States
(12) Patent Application Publication
(10) Pub. No.: US 2010/0186974 A1
(43) Pub. Date: Jul. 29, 2010

(54) Tine Adaptor

(76) Inventor: Ian Anthony Mitchell, Docklands (AU)

Correspondence Address: BEEM PATENT LAW FIRM, 53 W. JACKSON BLVD., SUITE 1352, CHICAGO, IL, 60604-3787, US

(21) Appl. No.: 12/300,047

(22) PCT Filed: May 8, 2007
(86) PCT No.: PCT/AU07/00612

§ 371 Date: Apr. 14, 2010

(30) Foreign Application Priority Data
May 8, 2006 (AU) 2006902771

(51) Int. Cl. A01B 35/28; A01B 39/22

(52) U.S. Cl. 172/166

(57) ABSTRACT

An adaptor for a support member includes a body having a mounting assembly for mounting the adaptor to the support member, and a rotor coupled to the body for rotation relative to the body, wherein the rotor is provided with a fixing assembly for fixing a disc coulter to the rotor. The mounting assembly may include one or more threaded shafts for mounting through apertures of the support member. Alternatively, the mounting assembly may include a tapered sleeve for mounting the adaptor by interference fit to a tapered fitting of the support member. A method of fitting a disc coulter to a cultivator tine, includes the steps of removing a tillage point from a point mount of the tine, mounting an adaptor to the point mount, and fixing a disc coulter to the adaptor.

### CROSS-REFERENCE TO RELATED APPLICATIONS

This application claims the benefit of priority from Australian patent application number 2006902771 filed May 8, 2006, and PCT application number PCT/AU2007/000612 filed May 8, 2007.

### BACKGROUND

1. Field of the Invention

This invention relates to an adaptor, and more particularly, but not exclusively to an adaptor for a cultivator tine or plough tine or similar agricultural machinery tillage support member.

2. Background of the Invention

It is known to use wide-line cultivators and disc seeders in agriculture. However, such machinery is very expensive, and, due to cost, ownership of both types of machines is out of reach for many farmers.

Some previously proposed machines incorporating disc coulters are provided with a disc undercarriage as well as a tined undercarriage. However such machines, while relatively straight-forward, are cumbersome to fit and change over, thus making them impractical and inefficient.

Examples of the present invention seek to provide a tine adaptor which will overcome or at least alleviate one or more of the above disadvantages of existing machinery.

### SUMMARY OF THE INVENTION

In accordance with one aspect of the present invention, there is provided an adaptor for a support member, the adaptor including a body having a mounting assembly for mounting the adaptor to the support member, and a rotor coupled to the body for rotation relative to the body, wherein the rotor is provided with a fixing assembly for fixing a disc coulter to the rotor.

Preferably, the support member is in the form of a tillage support member, and, even more preferably, is in the form of a cultivator tine.

Preferably, the mounting assembly comprises one or more threaded shafts for mounting through apertures of the tine. More preferably, the mounting assembly comprises a pair of threaded shafts for mounting through a pair of apertures of the tine designed for fitting a tillage point to the tine. Throughout the specification and the claims that follow, where the term “tillage point” is used, it will be understood to include other like items such as, for example, a scarifying point and a tillage share.

Alternatively, the mounting assembly comprises a tapered sleeve for mounting the adaptor by interference fit to a tapered fitting of the tine. The tapered sleeve may be shaped for mounting the adaptor by interference fit to a tapered fitting bolted to the tine.

Preferably, the rotor is attached to an axle shaft rotatably coupled within the body with one or more sealed bearings.

In a preferred example, the fixing assembly includes a plurality of threaded studs for mounting through apertures of the disc coulter.

Preferably, the mounting assembly is oriented relative to an axis of rotation of the rotor such that, in use, the axis of rotation will be offset from the direction of travel of the cultivator.

In accordance with another aspect of the present invention, there is provided a method of fitting a disc coulter to a cultivator tine, including the steps of removing a tillage point from a point mount of the tine, mounting an adaptor to the point mount, and fixing a disc coulter to the adaptor.

Preferably, the step of mounting the adaptor to the point mount is achieved by mounting a body of the adaptor to the point mount, and the step of fixing a disc coulter to the adaptor is achieved by fixing the disc coulter to a rotor of the adaptor which rotor is rotatable relative to the body.

Preferably, the step of removing the tillage point from the point mount is achieved by knocking off the tillage point from an interference fit with the point mount. More preferably, the step of mounting the adaptor to the point mount is achieved by knocking on the adaptor into an interference fit with the point mount.

### BRIEF DESCRIPTION OF THE DRAWINGS

The invention is described, by way of non-limiting example only, with reference to the accompanying drawings in which:

FIG. 1 is a perspective view of an adaptor for a cultivator tine in accordance with an example of the present invention;

FIG. 2A is a side view of the adaptor shown fitted to a cultivator tine;

FIG. 2B is a front view of the adaptor shown fitted to the cultivator tine;

FIG. 2C is a perspective view of the adaptor shown fitted to the cultivator tine;

FIG. 2D is a perspective view of an existing point configured for mounting to a tapered fitting of a cultivator tine;

FIG. 2E is a front view of an existing tapered fitting for coupling a point to a cultivator tine;

FIG. 3 is a diagrammatic side view of an existing tined cultivator machine;

FIG. 4 is a side view of a disc coulter;

FIG. 5 is a top view of an adaptor for a cultivator tine in accordance with a first example of the present invention, shown in exploded view with a disc coulter;

FIG. 6 is an opposite side view of the adaptor of FIG. 5, shown with the disc coulter;

FIG. 7 is a front view of the adaptor of FIG. 5, shown in exploded view with the disc coulter and a tapered fitting;

FIG. 8 is a side view of an adaptor for a cultivator tine in accordance with a second example of the present invention;

FIG. 9 is a bottom view of the adaptor of FIG. 8, shown in exploded view with the disc coulter;

FIG. 10 is an opposite side view of the adaptor of FIG. 8, shown with the disc coulter;

FIG. 11 is a front view of the adaptor of FIG. 8, shown with the disc coulter;

FIG. 12 is an exploded view of an adaptor for a cultivator tine in accordance with another example of the present invention;

FIG. 13 is a top sectioned view of the adaptor of FIG. 12 shown fitted to a cultivator tine and with a disc coulter fixed thereto; and

FIG. 14 is a front view of a plurality of adaptors in accordance with an example of the present invention shown with disc coulters fixed thereto in an arrangement exemplary of what may be used on a tined cultivator machine.

### DETAILED DESCRIPTION OF THE INVENTION

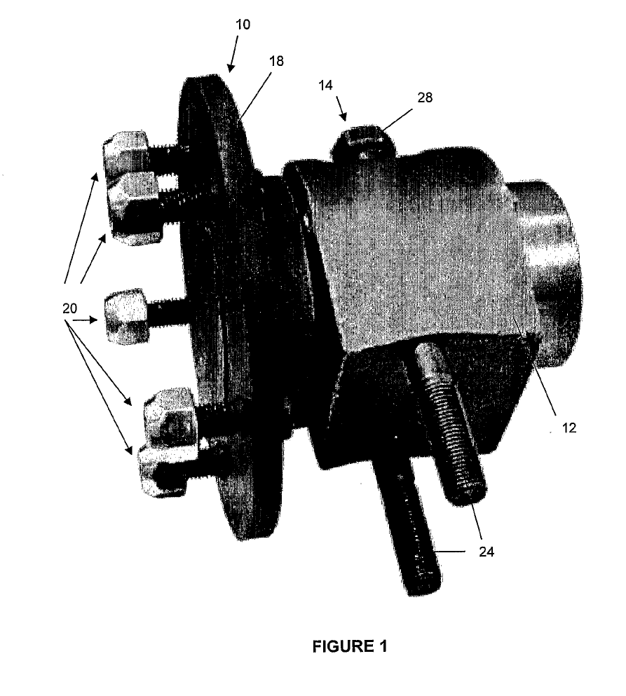

An adaptor 10 in accordance with an example of the present invention is shown in FIG. 1, and is configured to enable fitment of a disc coulter in place of a common tillage point on the end of a cultivator tine, for example of the well-known kind of spring loaded cultivator tine typically used on existing wide-line cultivator machinery. The adaptor 10 includes a body 12 having a mounting assembly 14 for mounting the adaptor 10 to the tine 16, and a rotor 18 coupled to the body 12 for rotation relative to the body 12. The rotor 18 is provided with a fixing assembly 20 for fixing a disc coulter 22 to the rotor 18.

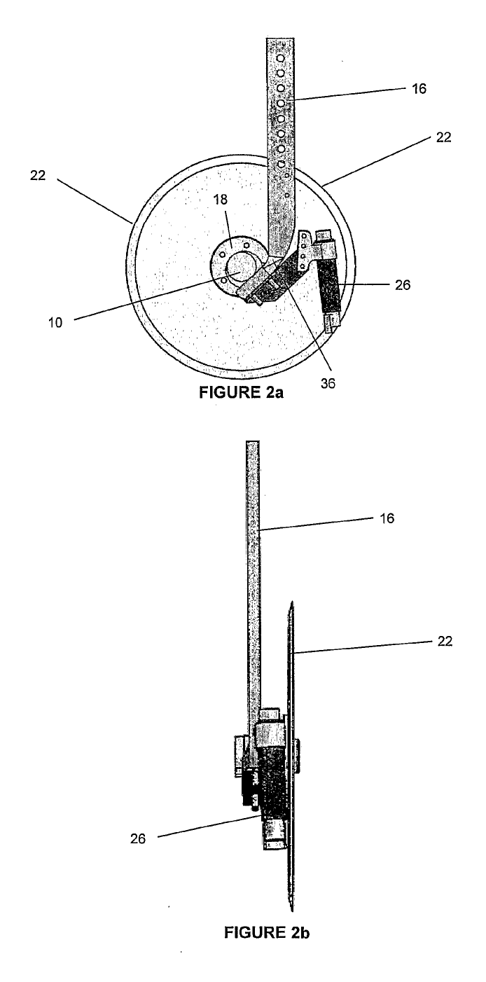

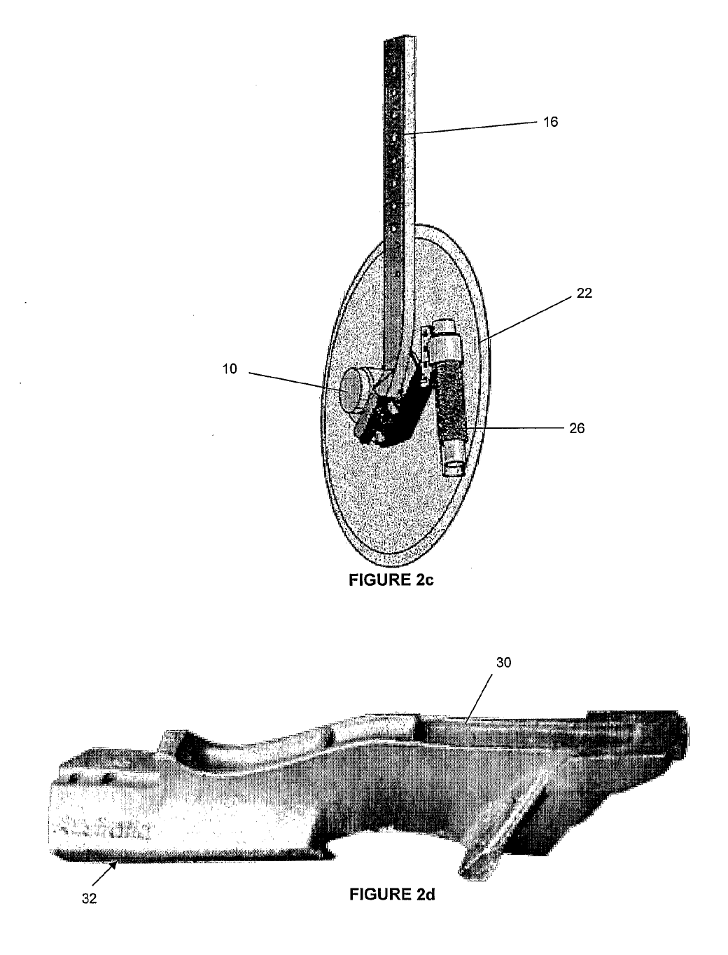

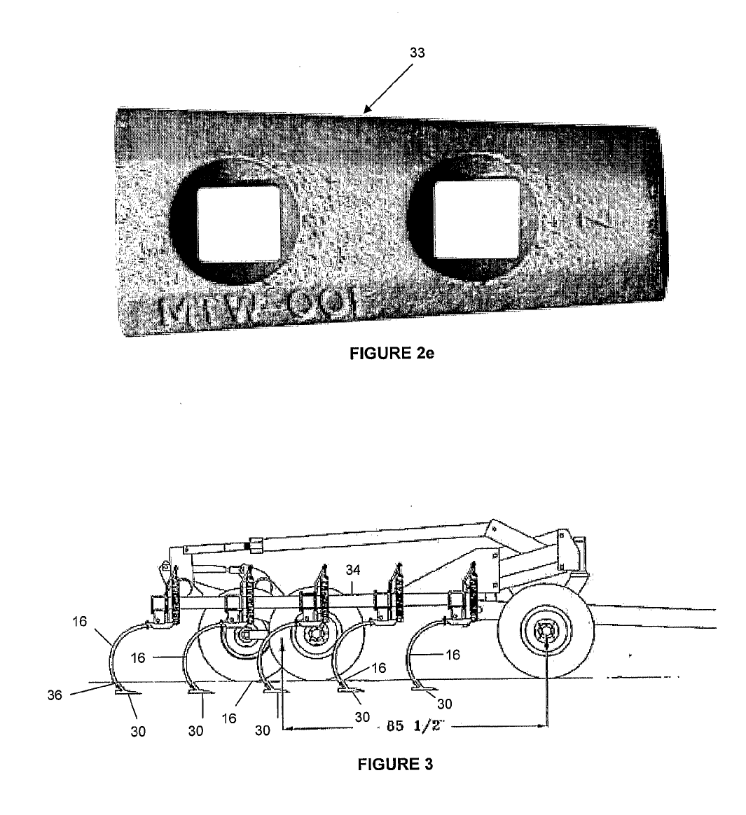

The “bolt-on” adaptor 10 shown in FIG. 1 has a pair of threaded bolt shafts 24 for mounting through apertures of the tine 16, in the manner shown in FIGS. 2a to 2c, which also show fitment of a seeding attachment 26 to the tine 16. It will be understood by those skilled in the art that the seeding attachment 26 shown in the drawings is an example of a common seeding attachment, and that other seeding attachments may be used. It is intended that a seeding attachment specifically for use with the present invention will be developed. As can be seen, the pair of threaded shafts 24 extend through the apertures in the tine 16, and are able to be fixed in place by tightening threaded nuts 28 on the threaded shafts 24 (see FIG. 1). In an alternative example, the threaded shafts 24 (or “stud”) may be embedded in the body 12 instead of being in the form of replaceable bolts, as shown.

FIG. 2d shows a previously proposed cultivator point 30 having a tapered sleeve 32 for mounting the point 30 by interference fit to a tapered fitting 33 (see FIG. 2e) which is bolted to the tine 16 in a previously proposed attachment arrangement. This type of attachment arrangement may also be used as an alternative to the threaded shaft 24 and nuts 28 of the adaptor 10 shown in FIGS. 1 to 2c.

FIG. 3 shows an existing form of tined cultivator machine having points 30 at the ends of tines 16. The tines 16 are spring-mounted to a frame 34 of the machine such that 30 the tines 16 are able to retract if excessive force is experienced, rather than breakage of the tines 16 occurring. This form of tined machine may be adapted by use of adaptors 10 of the present invention to replace the tillage points 30 with disc coulters 22.

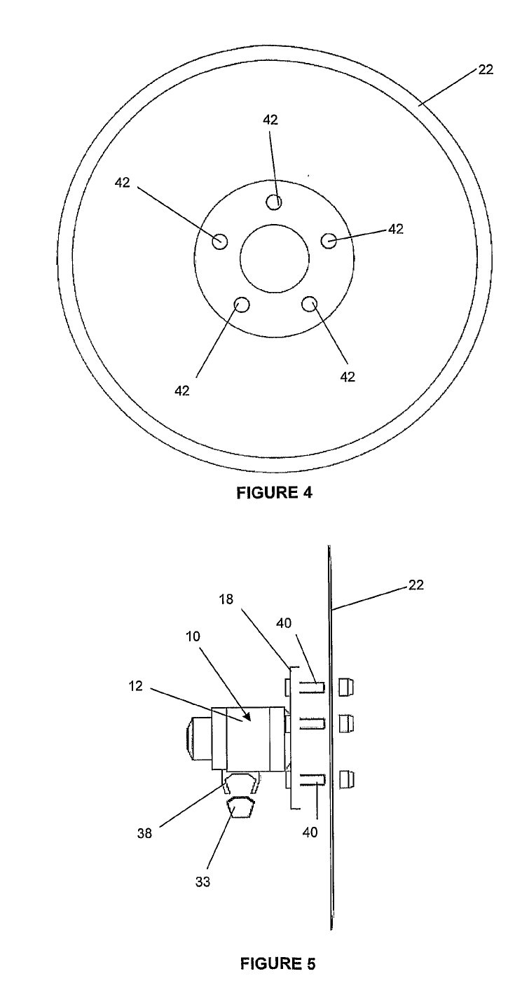

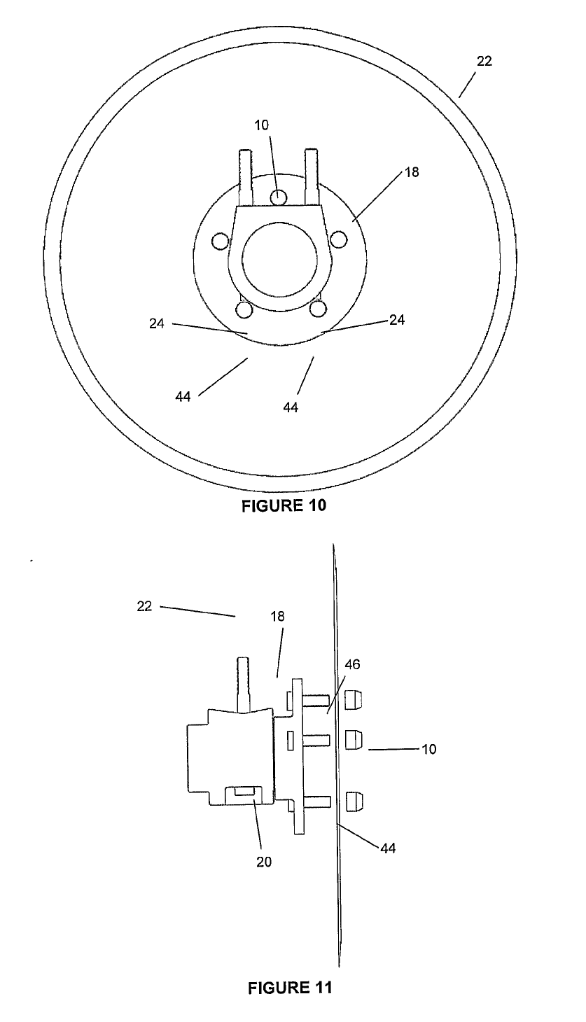

Advantageously, by using the adaptor 10 of the present invention, the method of fitting the disc coulter 22 in place of the tillage point 30 is simple and efficient, including the simple steps of removing the tillage point 30 from a point mount 36 of each tine 16, mounting the adaptor 10 to the point mount 36, and fixing the disc coulter 22 to the adaptor 10. Where the point mount 36 is in the form of a tapered fitting 33 of the kind shown in FIG. 2e, the tillage point 30 is removed from the point mount 36 by simply knocking off the tillage point 30 from an interference fit with the point mount 36. Similarly, the adaptor 10 (in the form of a “knock-on” adaptor as shown in FIGS. 4 to 7) is mounted to the point mount 36 by simply knocking on the adaptor 10 into an interference fit with the point mount 36. Alternatively, where the point mount is in the form of a pair of apertures for receiving threaded shafts 24 of the “bolt-on” adaptor 10 (i.e. as in FIGS. 2a to 2c, and FIGS. 8 to 11), removal of the tillage point 30 and mounting of the adaptor 10, respectively, is achieved by unthreading and threading the relevant nuts from/to the threaded shafts of the tillage point 30 and the adaptor 10.

FIGS. 4 to 7 show a “knock-on” adaptor 10 in accordance with a first example of the present invention wherein the mounting assembly 14 is in the form of a tapered sleeve 38 similar to the tapered sleeve 32 of the tillage point 30 shown in FIG. 2d. In FIG. 5, the adaptor 10 is shown in an exploded view in relation to the disc coulter 22, and the tapered fitting 33. The fixing assembly 20 includes a plurality of threaded studs 40 for mounting through apertures 42 of the disc coulter 22. Correspondingly threaded nuts 44 are used to fix the disc coulter 22 to the rotor 18.

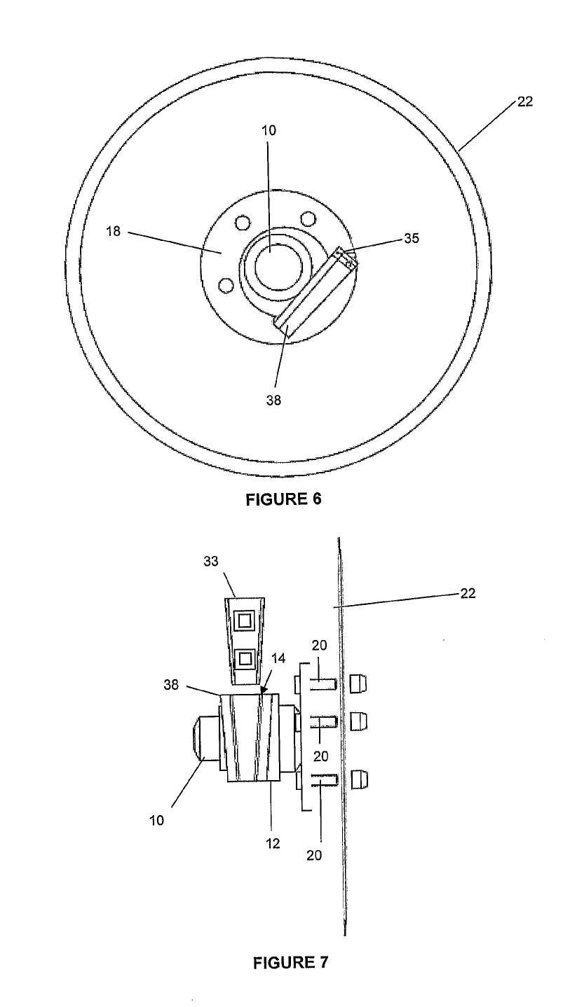

FIG. 6 shows an opposite side view of the adaptor 10 of FIG. 5 in front of the disc coulter 22, showing the integral design of the tapered sleeve 38 incorporated into the body 12 of the adaptor 10. With reference to FIG. 7, the tapered sleeve 38 is shaped for mounting the adaptor 10 by interference fit to the tapered fitting 33 providing the ability to efficiently interchange the adaptor 10 with a tillage point 30. As shown in FIG. 6, there may be provision for the insertion of a grub screw or pin through or over the tapered fitting 33 when inserted in the sleeve 38 to prevent accidentally decoupling of the fitting 33 and the sleeve 38.

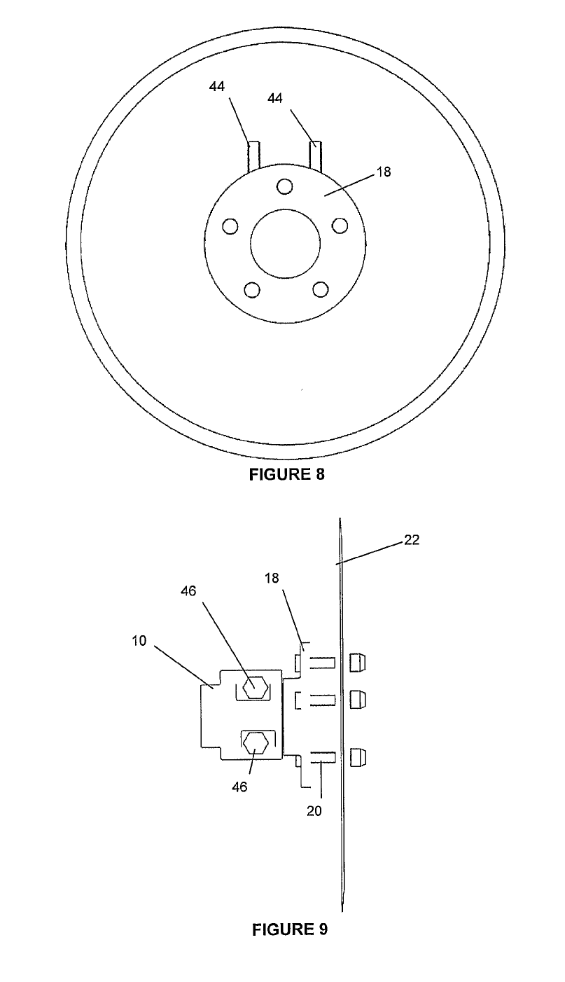

FIGS. 8 to 11 show a “bolt-on” adaptor 10 in accordance with a second example of the present invention wherein the mounting assembly 14 is in the form of a pair of threaded shafts 24, in a similar arrangement to the adaptor 10 shown in FIG. 1. However, the adaptor 10 shown in FIGS. 8 to 11 differs from the adaptor 10 shown in FIG. 1 as the threaded shafts 24 are part of bolts 44 which extend through the body 12, with heads 46 of the bolts 44 being on an opposite side of the body 12 from the threaded shafts 24, as shown in FIG. 11.

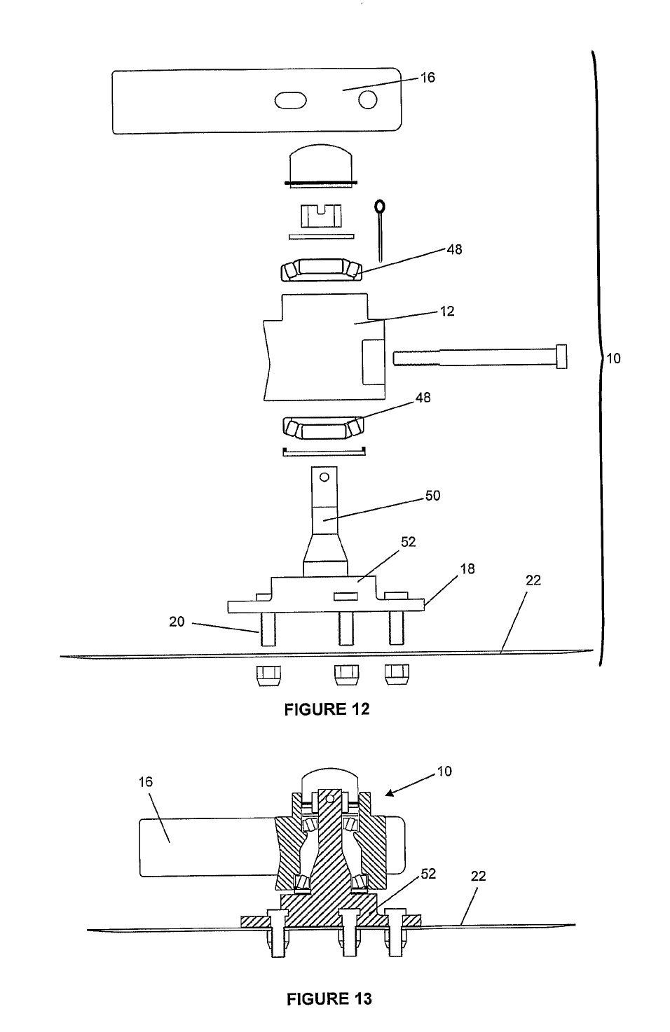

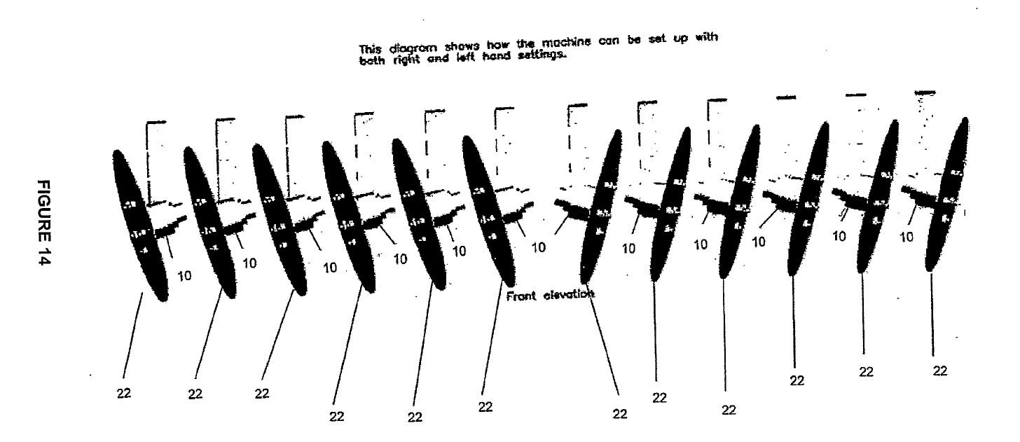

FIGS. 12 and 13 show an adaptor 10 in accordance with another example of the present invention. More specifically, FIG. 12 shows an exploded view of the adaptor 10, and FIG. 13 shows a top sectioned view of the adaptor 10 assembled and fitted to the tine 16, with the disc coulter 22 fixed to the rotor 18. As can be seen, bearings 48 are used to facilitate rotation of an axle shaft 50 (attached to the rotor 18) relative to and within the body 12. The bearings 48 are preferably of the sealed marine type to prevent ingress of foreign matter.

The rotor 18 has a skirt 52 which protrudes beyond the heads of the studs of the fixing assembly 20 so as to protect the sealed marine bearing 48, and to inhibit foreign matter building up between the body 12 and the rotor 18.

With reference to FIG. 14, there is shown an array of like adaptors 10 with disc coulters 22 fitted thereto, in an arrangement which may be used where the adaptors 10 are fitted to tines 16 of an existing 12-tine cultivator machine. The mounting assembly 14 of the adaptor 10 may be oriented relative to an axis of rotation of the rotor 18 such that, in use, the axis of rotation will be offset from the direction of travel of the cultivator so as to improve manipulation of the soil. The adaptor 10 may be configured to function either left-handed or right-handed, or different left-handed and right-handed models may be produced.

While an example of the present invention has been described above, it should be understood that it has been presented by way of example only, and not by way of limitation. It will be apparent to a person skilled in the relevant art that various changes in form and detail can be made therein without departing from the spirit and scope of the invention. Thus, the present invention should not be limited by the above described example.

The skilled addressee will appreciate that the body 12 of the adaptor 10 may be made from metal, e.g. steel, ductile iron or aluminum. The body 12 may be either fabricated or cast. Similarly, the axle shaft 50 to which the rotor 18 is attached may be manufactured from steel, or ductile or cast iron, or other material(s). The disc coulter 22 may be configured to operate at an offset to the forward direction of the cultivator machine in vertical and/or horizontal orientations, and the angle of the offset may be fixed or adjustable. Furthermore, although the adaptor 10 is described as being used with a cultivator tine, it will be understood that the adaptor may also be used with other types of support members such as, for example, the type of support member which may be suspended from an agricultural machine for cutting trash.

Advantageously, the present invention enables operators with tined cultivator and seeding machines to readily convert the machines from conventional point usage to a tine with a disc coulter attachment. The adaptor 10 of the present invention enables the operator to use the machine in the way it was originally intended, with the added benefit of a specifically designed tool which adds another dimension to the existing machine.

By use of the invention, operators are able to benefit from the advantages of disc coulters. More particularly, the disc format may enable fertiliser and seed to be placed with more precision than is often the case with cultivation, and will enable cutting through melons, vine and heavy stubbles more readily than with traditional tined points. The use of disc coulters may also alleviate the build up of refuse, and may result in less damage to the machine and its component parts due to lower resistance from the rolling rotation action. Furthermore, due to the discs offering lower resistance than conventional tined points, less power may be required to operate the machine, and consequently greater fuel economy may be achieved.

It is intended by the applicant to distribute an adaptor in accordance with an example of the present invention under the name Disca* Mate.

The reference in this specification to any prior publication (or information derived from it), or to any matter which is known, is not, and should not be taken as an acknowledgment or admission or any form of suggestion that that prior publication (or information derived from it) or known matter forms part of the common general knowledge in the field of endeavour to which this specification relates.

Throughout this specification and the claims which follow, unless the context requires otherwise, the word “comprise”, and variations such as “comprises” and “comprising”, will be understood to imply the inclusion of a stated integer or step or group of integers or steps but not the exclusion of any other integer or step or group of integers or steps.

What is claimed is:

1. An adaptor for a support member, the adaptor including:
a body having a mounting assembly for mounting the adaptor to the support member, and
a rotor coupled to the body for rotation relative to the body, wherein the rotor is provided with a fixing assembly for fixing a disc coulter to the rotor.

2. An adaptor as claimed in claim 1, wherein the mounting assembly comprises one or more threaded shafts for mounting through apertures of the support member.

3. An adaptor as claimed in claim 2, wherein the mounting assembly comprises a pair of threaded shafts for mounting through a pair of apertures of the support member designed for fitting a tillage point to the support member.

4. An adaptor as claimed in claim 1, wherein the mounting assembly comprises a tapered sleeve for mounting the adaptor by interference fit to a tapered fitting of the support member.

5. An adaptor as claimed in claim 4, wherein the tapered sleeve is shaped for mounting the adaptor by interference fit to a tapered fitting bolted to the support member.

6. An adaptor as claimed in claim 1, wherein the rotor is attached to an axle shaft rotatably coupled within the body with one or more sealed bearings.

7. An adaptor as claimed in claim 1, wherein the fixing assembly includes a plurality of threaded studs for mounting through apertures of the disc coulter.

8. An adaptor as claimed in claim 1, wherein the mounting assembly is oriented relative to an axis of rotation of the rotor such that, in use, the axis of rotation will be offset from the direction of travel of a cultivator of which the support member forms a part.

9. An adaptor as claimed in claim 1, wherein the support member is a tillage support member.

10. An adaptor as claimed in claim 9, wherein the tillage support member is a cultivator tine.

11. A method of fitting a disc coulter to a cultivator tine, including the steps of:
removing a tillage point from a point mount of the tine;
mounting an adaptor to the point mount; and
fixing a disc coulter to the adaptor.

12. A method as claimed in claim 11, wherein the step of mounting the adaptor to the point mount is achieved by mounting a body of the adaptor to the point mount, and the step of fixing a disc coulter to the adaptor is achieved by fixing the disc coulter to a rotor of the adaptor which rotor is rotatable relative to the body.

13. A method as claimed in claim 11, wherein the step of removing the tillage point from the point mount is achieved by knocking off the tillage point from an interference fit with the point mount.

14. A method as claimed in claim 11, wherein the step of mounting the adaptor to the point mount is achieved by knocking on the adaptor into an interference fit with the point mount.

15. A method as claimed in claim 11, wherein the adaptor is an adaptor for a support member, the adaptor including:
a body having a mounting assembly for mounting the adaptor to the support member, and
a rotor coupled to the body for rotation relative to the body, wherein the rotor is provided with a fixing assembly for fixing a disc coulter to the rotor.
